(19) United States
(12) Patent Application Publication
(10) Pub. No.: US 2019/0041860 A1
(43) Pub. Date: Feb. 7, 2019

(54) MODULAR ROBOTIC ROVER

(71) Applicant: Walmart Apollo, LLC, Bentonville, AR (US)

(72) Inventors: Nathan Glenn Jones, Bentonville, AR (US); John Paul Thompson, Bentonville, AR (US)

(21) Appl. No.: 16/054,085

(22) Filed: Aug. 3, 2018

Related U.S. Application Data
(60) Provisional application No. 62/540,774, filed on Aug. 3, 2017.

(51) Int. Cl. G05D 1/02; B60L 8/00; B60L 11/18; G01C 21/20; B60L 1/00; A01D 34/00; E01H 5/08; E01H 1/00; B60H 1/00

(52) U.S. Cl. CPC G05D 1/0212; G05D 1/0231; G05D 1/0242; B60L 8/003; B60L 11/18; G01C 21/20; G05D 2201/0203; A01D 34/008; E01H 5/08; E01H 1/00; B60H 1/00657; G05D 2201/0208; B60L 1/00

(57) ABSTRACT

Described herein are a modular robotic rover and a system for a modular robotic rover. An exemplary system includes a modular robotic rover that has a motor coupled to a drive train, a body frame, at least one battery and one or more sensors. The system further includes multiple removable attachments configured to couple to the rover's body frame. The attachments include at least a temperature-controlled compartment with a configurable size. The system also includes a cooling and heating mechanism with an integrated electrical interface that is removably coupled to the body frame and configured to control a temperature of the temperature-controlled compartment. The system also includes a control system to control the drive train and to provide power to the cooling and heating mechanism via the integrated electrical interface.

### RELATED APPLICATION

This application claims priority to U.S. Provisional Application No. 62/540,774 filed on Aug. 3, 2017, the content of which is hereby incorporated by reference in its entirety.

### BACKGROUND

Robotic devices may function autonomously or semi-autonomously by receiving instructions from a user or a remote device. Robotic devices can be used to perform various tasks, including transporting items.

### BRIEF SUMMARY

In one embodiment, a semi-autonomous modular robotic rover is provided. The modular robotic rover includes two front wheels attached to each other with a front axle, two back wheels attached to each other with a rear axle, a drive train coupled to the front or rear axle, and a motor coupled to the drive train to operate the drive train. The modular robotic rover also includes a body frame coupled to the front axle and the back axle. The body frame is configured to couple to multiple removable attachments, where the attachments include at least an attachment providing a temperature-controlled compartment. The size of the temperature-controlled compartment is configurable. The modular robotic rover further includes a cooling and heating mechanism with an integrated electrical interface. The cooling and heating mechanism is removably coupled to the body frame and is configured to control a temperature of the temperature-controlled compartment. The modular robotic rover also includes at least one battery coupled to the motor to provide power to the motor, one or more sensors configured to detect characteristics of an environment in which the semi-autonomous modular robotic rover is operating, and a control system that includes electronics to control the drive train and is coupled to the at least one battery. The control system is configured to provide power from the battery to the cooling and heating mechanism via the integrated electrical interface to control the temperature of the temperature-controlled compartment. The control system includes a processor and a memory, and the processor is configured to execute a temperature module. The temperature module when executed wirelessly transmits the temperature of the temperature-controlled compartment to a remote server, wirelessly receives instructions from the remote server to adjust the temperature of the temperature-controlled compartment to an updated temperature, and controls the cooling and heating mechanism to maintain the temperature-controlled compartment at the updated temperature.

In another embodiment, an autonomous modular robotic rover is provided. The modular robotic rover includes two front wheels attached to each other with a front axle, two back wheels attached to each other with a rear axle, a drive train coupled to the front or rear axle, and a motor coupled to the drive train to operate the drive train. The modular robotic rover also includes a body frame coupled to the front axle and the back axle. The body frame is configured to couple to multiple removable attachments, where the attachments include at least an attachment providing a temperature-controlled compartment. The size of the temperature-controlled compartment is configurable. The modular robotic rover further includes a cooling and heating mechanism with an integrated electrical interface. The cooling and heating mechanism is removably coupled to the body frame and is configured to control a temperature of the temperature-controlled compartment. The modular robotic rover also includes at least one battery coupled to the motor to provide power to the motor, one or more sensors configured to detect characteristics of an environment in which the semi-autonomous modular robotic rover is operating, and a control system that includes electronics to control the drive train and is coupled to the at least one battery. The control system is configured to provide power from the battery to the cooling and heating mechanism via the integrated electrical interface to control the temperature of the temperature-controlled compartment. The control system includes a processor and a memory, and the processor is configured to execute a temperature module. The temperature module when executed receives and stores temperature data from a remote server, monitors the temperature of the temperature-controlled compartment, and controls the cooling and heating mechanism to adjust the temperature of the temperature-controlled compartment based on the temperature data received from the remote server.

In yet another embodiment, a system for a modular robotic rover is provided. The system includes a modular robotic rover, multiple attachments configured to couple to a body frame of the rover, a cooling and heating mechanism removably coupled to the body frame, and a control system configured to couple to the modular robotic rover. The modular robotic rover includes a motor coupled to a drive train to operate the drive train, a body frame coupled to a front axle and a back axle, and at least one battery coupled to the motor to provide power to the motor. The modular robotic rover also includes one or more sensors configured to detect characteristics of an environment in which the modular robotic rover is operating. The multiple attachments include at least a temperature-controlled compartment. The size of the temperature-controlled compartment is configurable. The cooling and heating mechanism includes an integrated electrical interface, and is configured to control a temperature of the temperature-controlled compartment. The control system includes electronics to control the drive train, and is coupled to the battery. The control system is configured to provide power to the cooling and heating mechanism via the integrated electrical interface to control the temperature of the temperature-controlled compartment.

### BRIEF DESCRIPTION OF DRAWINGS

The accompanying drawings, which are incorporated in and constitute a part of this specification, illustrate one or more embodiments of the invention and, together with the description, help to explain the invention. The embodiments are illustrated by way of example and should not be construed to limit the present disclosure. In the drawings:

FIG. 1A is a schematic illustrating an exemplary modular robotic rover, according to an example embodiment;

FIG. 1B illustrates an exemplary electromagnetic mount, according to an example embodiment;

FIG. 2 is schematic illustrating an exemplary modular robotic rover, according to an example embodiment;

FIG. 3 is a schematic illustrating a perspective view of an exemplary rover, according to an example embodiment;

FIG. 4 is a schematic illustrating a perspective view of another exemplary rover, according to an example embodiment;

FIG. 5 is a schematic illustrating a perspective view of an exemplary rover with multiple temperature-controlled compartments, according to an example embodiment;

FIG. 6 is a schematic illustrating a perspective view of an exemplary rover, according to an example embodiment;

FIG. 7A schematically shows exemplary body configurations for the rover, according to an example embodiment;

FIG. 7B schematically shows exemplary configurations for an electromagnetic mount;

FIGS. 8A and 8B show perspective views of an exemplary drive train and wheels for use with a robotic rover, according to an example embodiment;

FIG. 9 is a schematic illustrating an exemplary rover with an attachment, according to an example embodiment;

FIG. 10 schematically shows an exemplary electronic configuration for a rover, according to an example embodiment;

FIG. 11 shows exemplary control system electronics, according to an example embodiment;

FIG. 12 block diagram showing a rover control system implemented in modules, according to an example embodiment;

FIG. 13A is a flowchart showing an exemplary method for a semi-autonomous modular robotic rover, according to an example embodiment;

FIG. 13B is a flowchart showing an exemplary method for an autonomous modular robotic rover, according to an example embodiment;

FIG. 14 illustrates a network diagram depicting a system for implementing the rover control system, according to an example embodiment; and

FIG. 15 is a block diagram of an exemplary computing device that can be used to implement exemplary embodiments of the rover control system described herein.

### DESCRIPTION OF EXEMPLARY EMBODIMENTS

Conventionally robotic rovers may be expensive and may be configured to perform only one or two discrete tasks. The present disclosure discusses a modular robotic rover whose components are configured in a modular manner, so that the modular robotic rover described herein can be used to perform a variety of tasks while lessening the overall cost of the rover.

In an exemplary embodiment, a modular robotic rover includes a mounting point that enables coupling of a variety of attachments or tools to the rover, increasing the number of tasks that the rover can perform. The modular nature of the robotic rover described herein enables others to attach a variety of tools and develop software for the rover to perform various tasks.

The modular robotic rover also includes a frame with drive motors, batteries and controlling electronics. The battery of the rover may be recharged using solar energy, or it may be connected to a power outlet or fast-charging stations. Mount points on top of the frame and under the frame allow different attachments or tools to be bolted to the rover or attached without bolts to serve different tasks. The control electronics included on the rover allows the rover to handle different tasks, and can operate in a fully autonomous manner, a semi-autonomous manner, or a fully-manual manner where the rover is remotely driven by a user via a transmitter.

In one embodiment the modular robotic rover may be attached to different types of cargo bays. For example, the rover may be attached to a fully enclosed compartment or cargo bay (like a delivery vehicle). In another example, the rover may be attached to a partially enclosed cargo bay (like a truck bed). In another example, the rover may be attached to a temperature-controlled compartment for cooling or heating items. The rover may also be attached to various tools, such as tools for landscaping, including but not limited to a mowing deck and a bush hogging deck. The rover may also be attached to a snow blower, a leaf blower, or a street sweeper. The rover may also include an imaging device or camera.

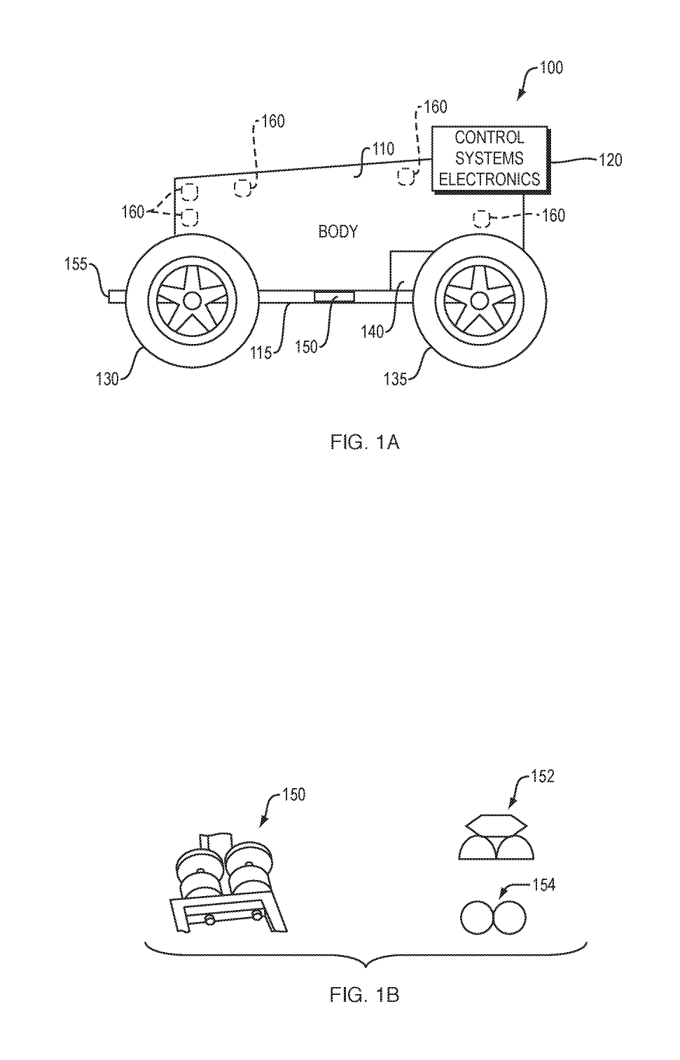

FIG. 1A is a schematic illustrating an exemplary modular robotic rover 100, according to an example embodiment. The exemplary modular robotic rover 100 includes a body 110 and a body frame 115. In an example embodiment, the body 110 is a compartment configured to store items. In another embodiment, the body 110 is a partially enclosed cargo bay to store items. In an example embodiment, the body frame 115 can be configured to be different sizes. For example, the body frame 115 may be extended lengthwise or widthwise to change the size of the body frame 115. Control systems electronics 120 is operatively coupled to the body 110 of the rover 100. The rover 100 also includes front wheels 130 and back wheels 135. A battery 140 is operatively coupled to the rover 100 and a drive train for operating and driving the wheels 130, 135. In an example embodiment, the battery 140 is a 12 volt battery. In an example embodiment, the rover 100 includes two 12 volt batteries. In an example embodiment, the rover 100 includes one or more solar panels for charging the battery 140.

An electromagnetic mount 155 is coupled to the body frame 115 at the front of the rover 100. Another electromagnetic mount 150 is coupled to the body frame 115 under the rover 100 that is on a bottom surface of the body frame 115. In example embodiments, the electromagnetic mounts 150, 155 may be coupled on different surfaces of the body frame 115, including the front side or surface of the body frame 115 (i.e. near or between the front wheels 130 of the rover 110), the back side or surface of the body frame 115 (i.e. near or between the back wheels 135 of the rover 100), a side surface of the body frame 115, a bottom surface of the body frame 115, or a top surface of the body frame 115. In an example embodiment, the rover 100 may include one electromagnetic mount, or more than two electromagnetic mounts. Each of the electromagnetic mounts 150, 155 are configured to attach or couple to one or more attachments. The electromagnetic mounts 150, 155 enable the rover 100 to removably attach to different types of attachments or tools to enable the rover to perform a variety of tasks. Exemplary attachments include, but are not limited to, landscaping tools, a mowing deck, a bush hogging deck, a leaf blower, a snow blower, a street sweeper, a plow, a tiller, a dethatcher, a sprayer (an agricultural sprayer), a ground aerator, an edger, a weedwacker, a hedge trimmer, and other attachments.

The rover 100 also includes at least one sensor 160 coupled to the body 110. The sensor 160 detects various characteristics of the rover 100 and the environment surrounding the rover 100. Although sensors 160 are shown as coupled at various locations on the body 110, it should be understood that the sensor 160 may be coupled to the body 110 at any location, for example, including but not limited to, an outer surface of the body 110, an inner surface of the body 110, a front surface of the body 110 (e.g., near the front wheels 130), a back surface of the body 110 e.g. near the back wheels 135), a side surface of the body 110, a front surface of the body 110, and a bottom surface of the body 110 (e.g. near the body frame 115). The sensors 160 can include, but are not limited to, a distance sensor, a laser, an infrared sensor, an image sensor or imaging device, an optical sensor, a temperature sensor, a chemical substance sensor, a gas emission sensor, a humidity sensor, a location sensor, a light sensor, a speed sensor, a motion sensor, a water sensor, and others.

The control systems electronics 120 includes electronics to control the drive train for operating the wheels 130, 135 and is coupled to the battery 140. The control systems electronics 120 includes at least a memory and a processor to store data and execute instructions or software code. The control systems electronics 120 may also include a communication interface to enable connection with a network. The control system electronics 120 is configured to draw power from the battery 140 and provide it to various components of the rover 100. In an example embodiment, the control systems electronics 120 may perform analytics for power management to determine the manner in which power from the battery 140 is distributed or provided to the various components of the rover 100. Each of the electromagnetic mounts 150, 155 and sensors 160 are operatively coupled or connected (via wired or wireless connections) to the control systems electronics 120, enabling transmission of data and power between the electromagnetic mounts 150, 155 and the sensors 160, and the control systems electronics 120.

FIG. 1B illustrates an exemplary electromagnetic mount 150, according to an example embodiment. FIG. 1B also includes a schematic showing perspective views 152 and 154 of the electromagnetic mount 150. The electromagnetic mount shown in FIG. 1B may also be the electromagnetic mount 155 of FIG. 1A. The electromagnetic mount 150 is an electronically controlled electromagnet connection. The electromagnetic mount 150 is controlled by the control systems electronics 120. The electromagnetic mount 150 is configured to attach or couple to a corresponding electromagnet or magnet on an attachment to secure the attachment and enable the rover 100 to perform various tasks. In other embodiments, the attachment may include ferrous material to enable attaching to the electromagnet mount 150. Exemplary attachments include, but are not limited to, landscaping tools, a mowing deck, and a bush hogging deck, a leaf blower, a snow blower, a street sweeper, and others.

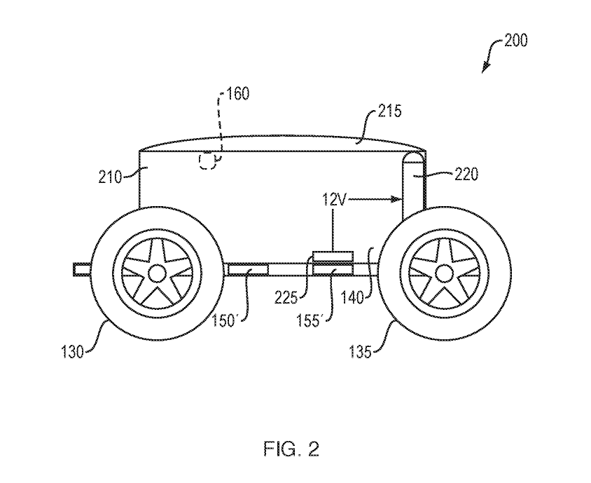

FIG. 2 is schematic illustrating an exemplary modular robotic rover 200, according to an example embodiment. The exemplary rover 200 includes a temperature-controlled compartment 210 with a movable lid 215 to store one or more items. The temperature-controlled compartment 210 may be used to cool or heat items stored within. The rover 200 also includes a cooling and heating mechanism 220. In some embodiments, the cooling and heating mechanism 220 may be configured to heat and cool the temperature-controlled compartment 210. The cooling and heating mechanism 220 may include a cooling pump and/or a heating pump or other suitable means to control the temperature of the compartment 210. The cooling and heating mechanism 220 includes an integrated electrical interface that couples or connects to the control systems electronics 120. The cooling and heating mechanism 220 is removably coupled to the rover 200.

The rover 200 also includes electromagnetic mounts 150′ and 155′ as discussed in relation to FIG. 1A. In one embodiment, one of the electromagnetic mounts, for example 155′, may be configured for wireless power delivery and may be coupled to a wireless power receiver 225. In an example embodiment, the electromagnetic mount 155′ includes a transmitter coil and the wireless power receiver 225 includes a receiver coil. Using inductive coupling and/or resonant power transfer principle, the rover 200 transmits power from the battery via the electromagnetic mount 155′ and the wireless power receiver 225 to the attachments coupled to the electromagnetic mount 155′ thereby powering the attachments motor (if needed). In some embodiments, the wireless power receiver 225 is included in the electromagnetic mount 155′ and forms a single assembly. The rover 200 depicted in FIG. 2 can also include one or more components described in relation to exemplary rover 100 of FIG. 1A, for example, front wheels 130, back wheels 135, sensors 160, control systems electronics 120 (not shown), and others.

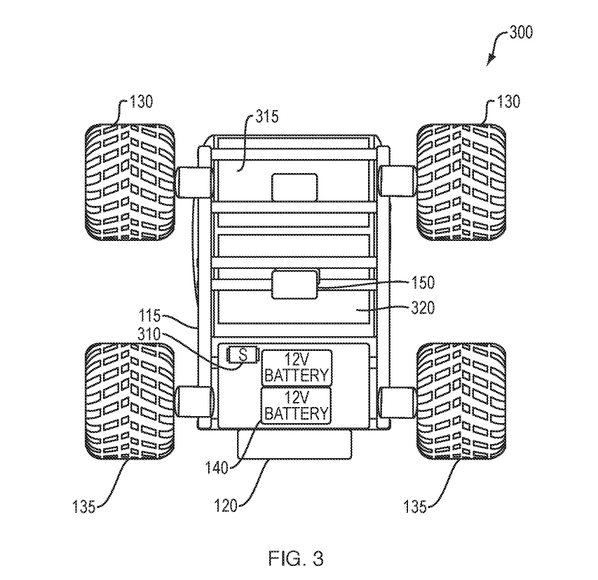

FIG. 3 is a schematic illustrates a perspective view of an exemplary rover 300, according to an example embodiment. The rover 300 includes multiple temperature-controlled compartments 315 and 320. The rover 300 includes two 12-volt batteries 140, as described in relation to FIG. 1A. In an example embodiment, the cooling and heating mechanism for the temperature-controlled compartments 315 and 320 utilizes 12 volts for operation, and the rover 300 includes a stepdown regulator 310 that converts the 24 volt battery 140 to 12 volts. The rover 300 depicted in FIG. 3 can also include one or more components described in relation to exemplary rover 100 of FIG. 1A and exemplary rover 200 of FIG. 2, for example, body frame 115, front wheels 130, back wheels 135, electromagnetic mount 150, sensors 160 (not shown), control systems electronics 120, compartment lid 125, cooling and heating mechanism 210, and others.

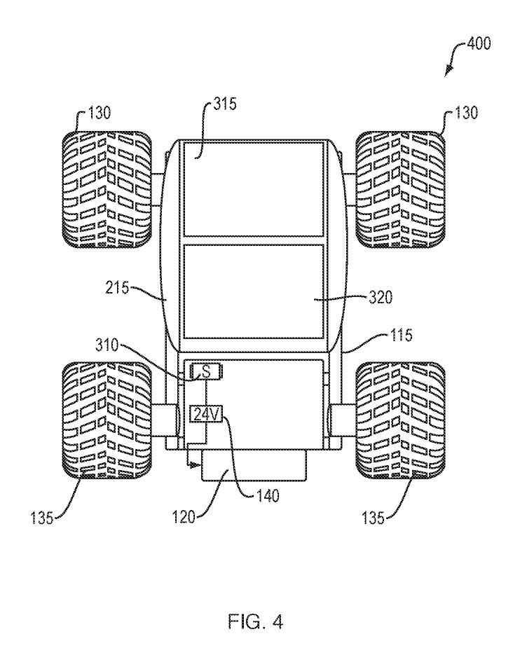

FIG. 4 is a schematic illustrating a perspective view of another exemplary rover 400, according to an example embodiment. The rover 400 includes multiple temperature-controlled compartments 315 and 320, and a temperature-controlled compartment lid 215 as described in relation with FIG. 2. In an example embodiment, each of the temperature-controlled compartments 315 and 320 has its own lid. That is, the rover 400 includes two lids for the compartments. The rover 400 depicted in FIG. 4 can also include one or more components described in relation to exemplary rover 100 of FIG. 1A, exemplary rover 200 of FIG. 2 and exemplary rover 300 of FIG. 3, for example, body frame 115, front wheels 130, back wheels 135, electromagnetic mount 150 (not shown), sensors 160 (not shown), control systems electronics 120, cooling and heating mechanism 210 (not shown), battery 140, stepdown regulator 310, and others.

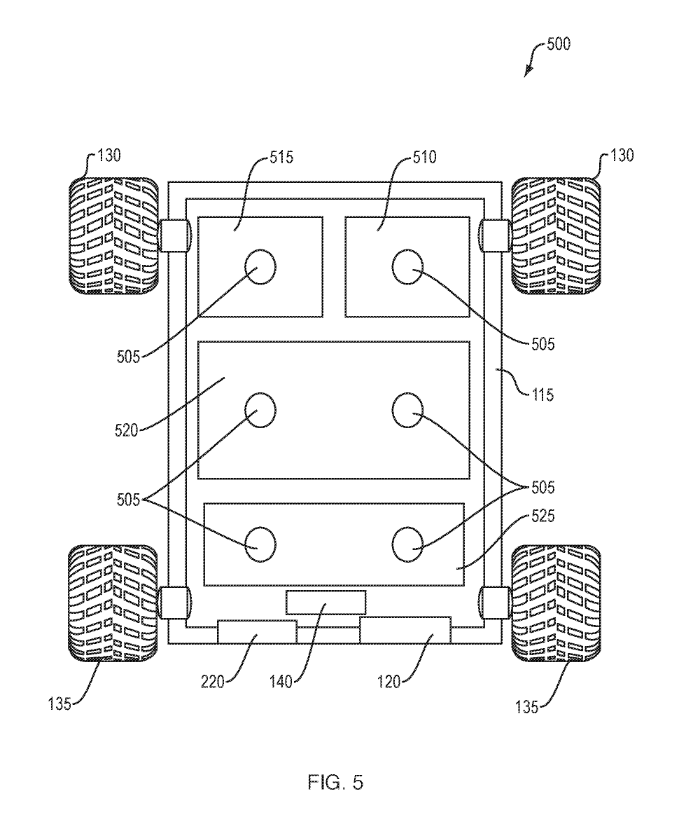

FIG. 5 is a schematic illustrating a perspective view of an exemplary rover 500 with multiple temperature-controlled compartments, according to an example embodiment. As shown, the rover 500 includes multiple temperature-controlled compartments of varying size, such as compartment 510, compartment 515, compartment 520, and compartment 525. Each of compartments 510, 515, 520 and 525 is configured to hold or store items within. The rover also includes a battery 140 as described in relation to FIG. 1A, a cooling or heating mechanism 220 as described in relation to FIG. 2. The cooling or heating mechanism 220 and the control systems electronics 120 are coupled to the battery 140. The rover 500 also includes multiple vents or ducts 505 formed in a bottom surface of the body frame 115. The vents or ducts 505 are formed in a manner so that it enables connection or engagement with temperature-controlled compartments of varying sizes and at varying locations on the rover 500. Each of the vents or ducts 505 is connected to the cooling or heating mechanism 220 to enable cooling or heating of a temperature-controlled compartment coupled to the rover. Each of the compartments 510, 515, 520, and 525 includes an aperture that corresponds to the vent or duct 505 in the rover 500. The multiple vents or ducts 505 may be formed in the body frame 115 in a fixed or permanent manner, and temperature-controlled compartments may be provided of a particular shape or size such that they can engage with the vents or ducts formed in the rover. For example, as shown in FIG. 5, the compartment 520 is of such a size that it engages or couples to two of the vents or ducts 505 in the body frame 115, whereas the compartment 510 is of such a size that it engages or couples with one of the vents of ducts 505 in the body frame 115.

In an example embodiment, the temperature of each of the compartments 510, 515, 520 and 525 can be controlled individually. For example, one compartment may be used to keep items cold, while another compartment may be used to keep items warm. Each of the compartments 510, 515, 520, and 525 may include one or more sensors, for example, at least a temperature sensor. Coupling the compartment 510, 515, 520 and 525 to the rover 500 causes the compartment to operatively connect to the vents or ducts 505, and also operatively connect to the control systems electronics 120 and the cooling or heating mechanism 220. In an example embodiment, the compartment 510, 515, 520, and 525 wirelessly connects to the control systems electronics 120. The control systems electronics 120 may be configured to obtain temperature data of the compartments coupled to the rover 500, and operate or control the cooling or heating mechanism 220 to adjust the temperature of the compartments coupled to the rover 500.

Although compartments 510, 515, 520, and 525 are shown of a particular size and are coupled to the rover 500 at particular locations, it should be understood that fewer or more compartments of different sizes may be coupled to the rover 500 at any suitable location in any arrangement.

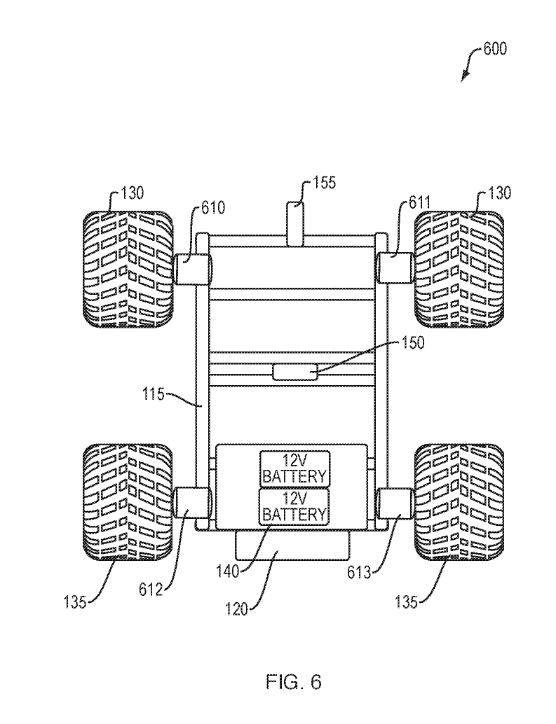

FIG. 6 is a schematic illustrating a perspective view of an exemplary rover 600, according to an example embodiment. FIG. 6 shows the body frame 115 of rover 600 and components coupled to the body frame 115. The rover 600 includes one or more components described in relation to FIGS. 1A, 2, 3, and 4. For example, the rover 600 includes body frame 115, front wheels 130, back wheels 135, control systems electronics 120, battery 140, electromagnetic mount 150, and electromagnetic mount 155. The rover 600 also includes four motors 610, 611, 612, and 613 coupling each of the four wheels 130, 135 to the body frame 115. The motors 610-613 may be 12 volt motors, and are operatively coupled to the battery 140 and the control systems electronics 120. The control systems electronics 120 is configured to operate and control the wheels 130, 135 by operating and controlling the motors 610-613. Each of the motors 610-613 may be controlled separately or independently of each other, thus, enabling four-wheel drive for the rover.

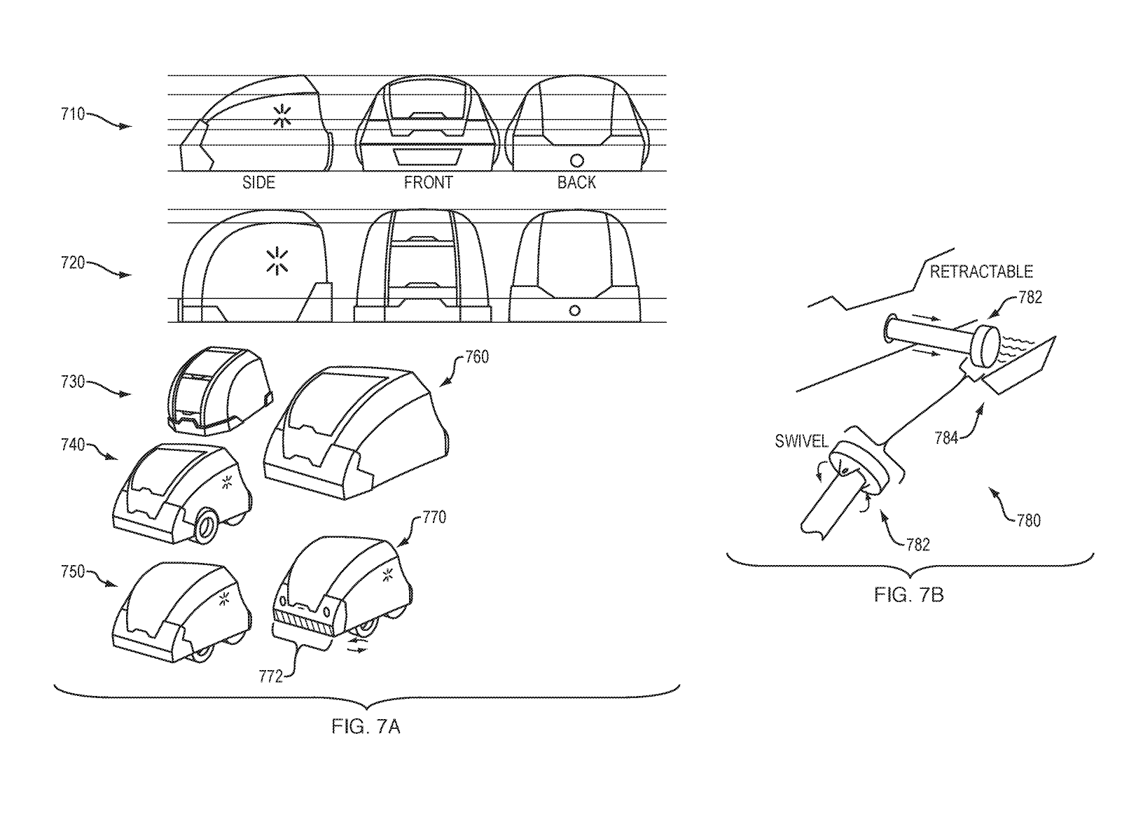

FIG. 7A schematically shows exemplary body configurations for the rover, according to example embodiments. A first exemplary configuration for the body 710 is illustrated. A second exemplary configuration for the body 720 is illustrated and has a size and shape that varies from the first exemplary configuration for the body 710. The second exemplary configuration for the body 720 also includes two compartments as illustrated by the front view of the configuration. In another exemplary configuration the body 730 includes two compartments and two corresponding lids on the outer surface of the body 730 as illustrated. Another exemplary configuration for the body 740 is illustrated, where the wheels for the rover are exposed. Another exemplary configuration for the body 750 is illustrated, where the wheels for the rover are hidden. An exemplary configuration where the body 760 is colored or shaded is also illustrated. An exemplary configuration for the body 770 includes wheels that can swivel, and lights 772 at the front of the body 770.

FIG. 7B schematically shows exemplary configurations for an electromagnetic mount 780. The electromagnetic mount 780 may be retractable. That is, the electromagnetic mount 780 may extend out from the body of rover and retract into the body of the rover. The electromagnetic mount 780 may swivel, and is configured to attach to multiple different attachments 784.

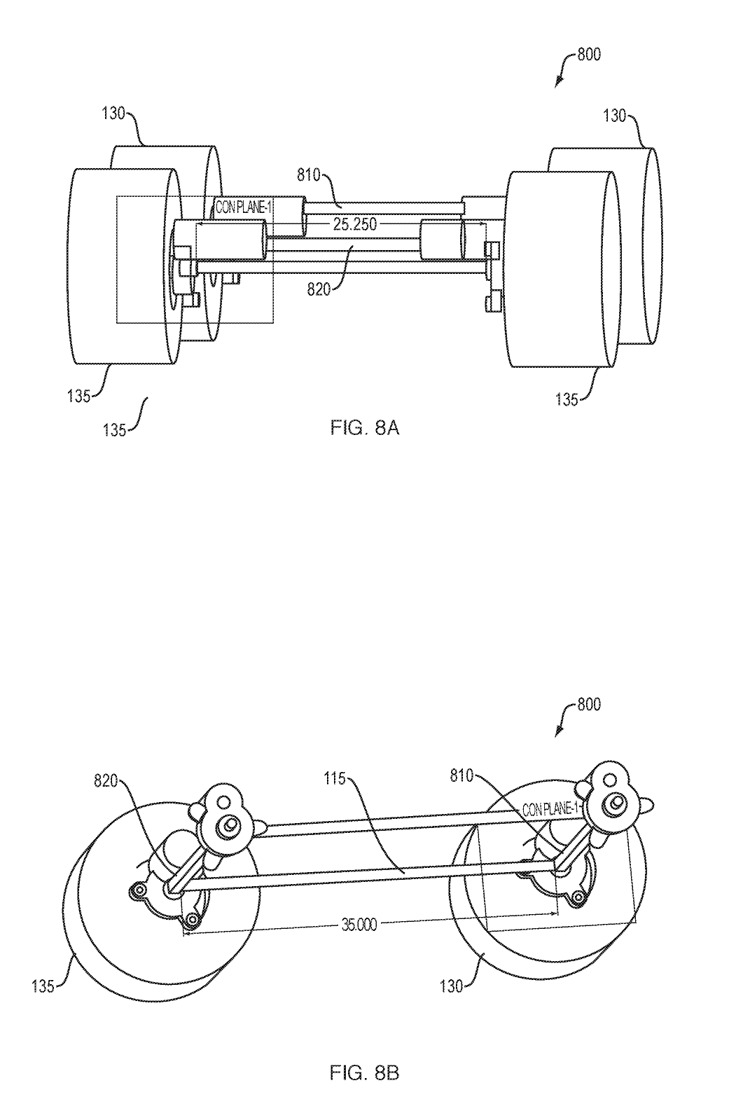

FIGS. 8A and 8B show perspective views of an exemplary drive train 800 and wheels for use with a robotic rover, according to an example embodiment. The drive train 800 includes two front wheels 130 coupled to each other using a front axle 810, and two back wheels 135 coupled to each other using a back axle 820. FIG. 8B is a cross-sectional view of the exemplary drive train 800, showing one of the front wheels 130 and one of the back wheels 135, coupled to each other via the body frame 115. FIG. 8B also shows the front axle 810 and back axle 820.

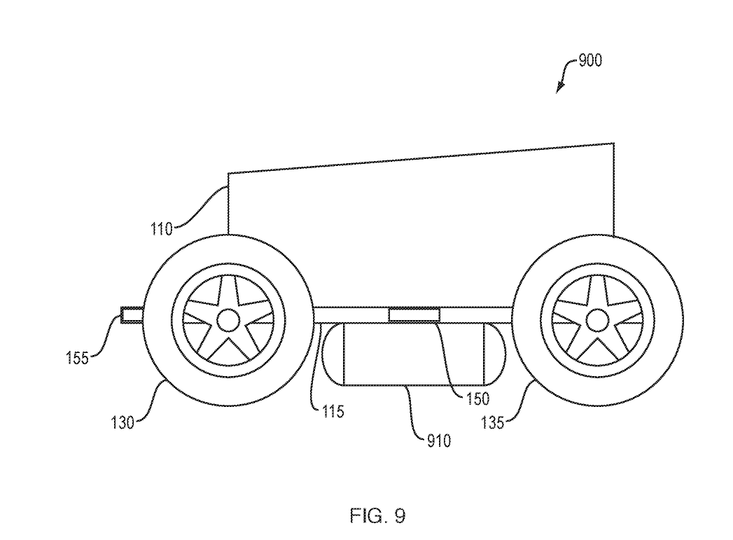

FIG. 9 is a schematic illustrating an exemplary rover 900 with an attachment, according to an example embodiment. The rover 900 includes one or more components described in relation to FIG. 1A, for example, body 110, body frame 115, front wheels 130, back wheels 135, electromagnetic mounts 150 and 155, battery 140 (not shown), control systems mechanisms 120 (not shown), and others. The rover 900 also includes an attachment 910 removably mounted at the electromagnetic mount 150. In an example embodiment, the attachment 910 is a mowing deck enabling the rover to perform the task of mowing an area or lawn. In another example embodiment, the attachment 910 is a bush hogging deck enabling the rover to perform the task of trimming bushes or weeds. In another example embodiment, the attachment 910 is a snow blower enabling the rover to perform the task of blowing snow or clearing snow from an area. In another example embodiment, the attachment 910 is a street sweeper enabling the rover to perform the task of sweeping or cleaning streets. The control systems mechanisms 120 may be configured to operate and control power to the attachment 910 via the electromagnetic mount 150.

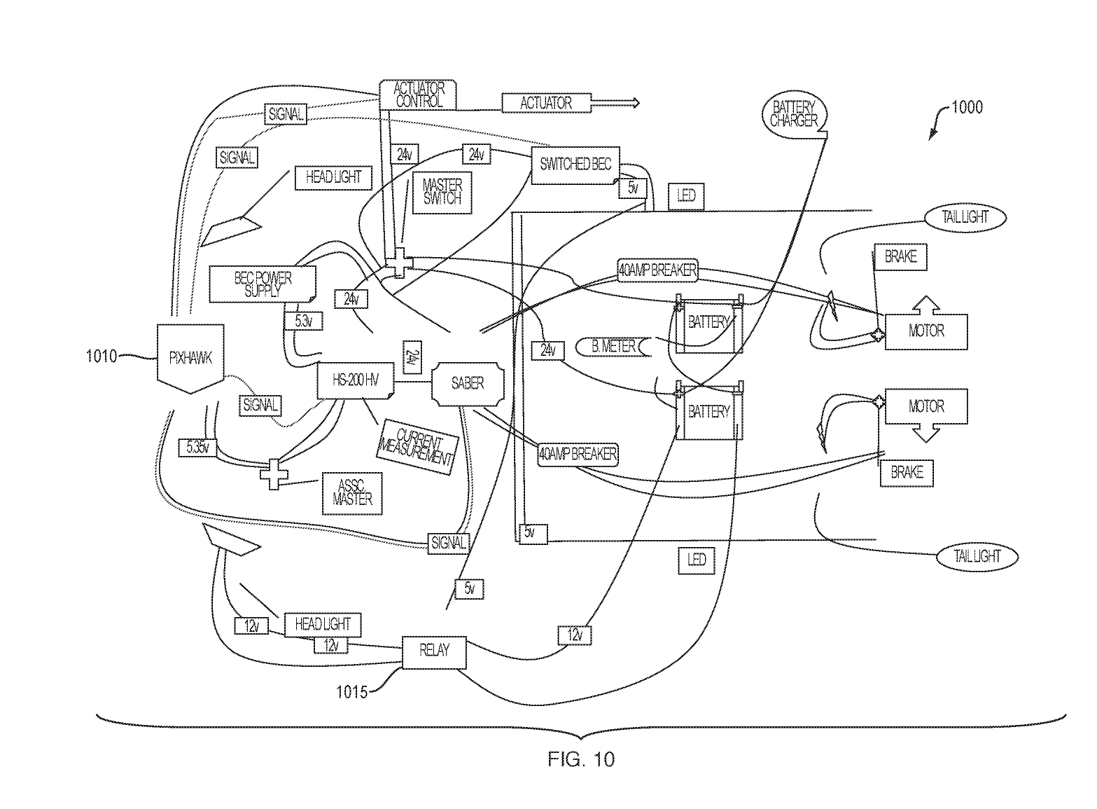

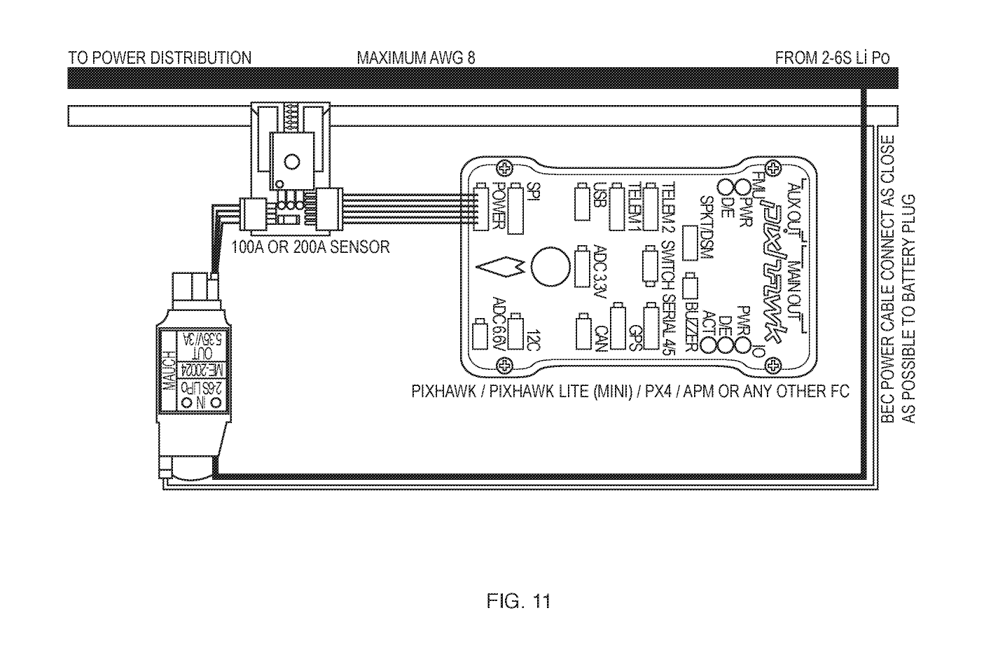

FIG. 10 schematically shows an exemplary electronics configuration 1000 for a rover, according to an example embodiment. As shown in FIG. 10, the electronics configuration 1000 for the rover includes various components described herein, for example, batteries, motors, control systems electronic (e.g., Pixhawk 1010 which is described further with relation to FIG. 11), electromagnetic mount (e.g., relay 1015), and others.

FIG. 11 shows exemplary control system electronics 1100, according to an example embodiment. FIG. 11 depicts a Pixhawk control system board that can be used as the control system electronics for the modular robotic rover described herein. The Pixhawk control system board provides high-end autopilot hardware for rovers, drones and other unmanned vehicles. The Pixhawk control system board runs an efficient real-time operating system (RTOS), which provides a POSIX-style environment (i.e. printf( ), pthreads, /dev/ttyS1, open( ), write( ), poll( ), ioctl( ), etc). The software can be updated with an USB bootloader. An exemplary Pixhawk control system includes 168 MHz Cortex M4F CPU (256 KB RAM, 2 MB Flash), sensors (e.g., motion sensors, acceleration sensors, gyro sensors, magnetic sensors, barometric sensor, and others), microSD slot, universal asynchronous receiver/transmitters (UARTs), controller area network (CAN), inter-integrated circuit (I²C), serial peripheral interface bus (SPI), analog to digital converter (ADC), and other components.

In some embodiments, the rover is a semi-autonomous rover where the control systems electronics 120 is configured to receive instructions from a remotely located server (e.g., server 1430) to navigate the rover and perform tasks based on the attachments coupled to the rover. The semi-autonomous rover may receive an instruction from the server, and the server may wait for confirmation of completion of the instruction prior to transmitting the subsequent instruction. For example, in one embodiment, rather than making decisions regarding the temperature of a storage compartment onboard the rover, the control system electronics may transmit a detected temperature of a compartment to the remote server and receive instructions to alter the temperature of the compartment from the remote server. Alternatively, the server may transmit a set of instructions at a time to the rover.

In other embodiments, the rover is an autonomous rover where the control systems electronics 120 is configured to store, analyze and execute instructions for navigating the rover and performing various tasks. The autonomous rover does not receive step-by-step instructions for performing a task or navigating a route. The autonomous rover may receive updated data or information from the server when it is available.

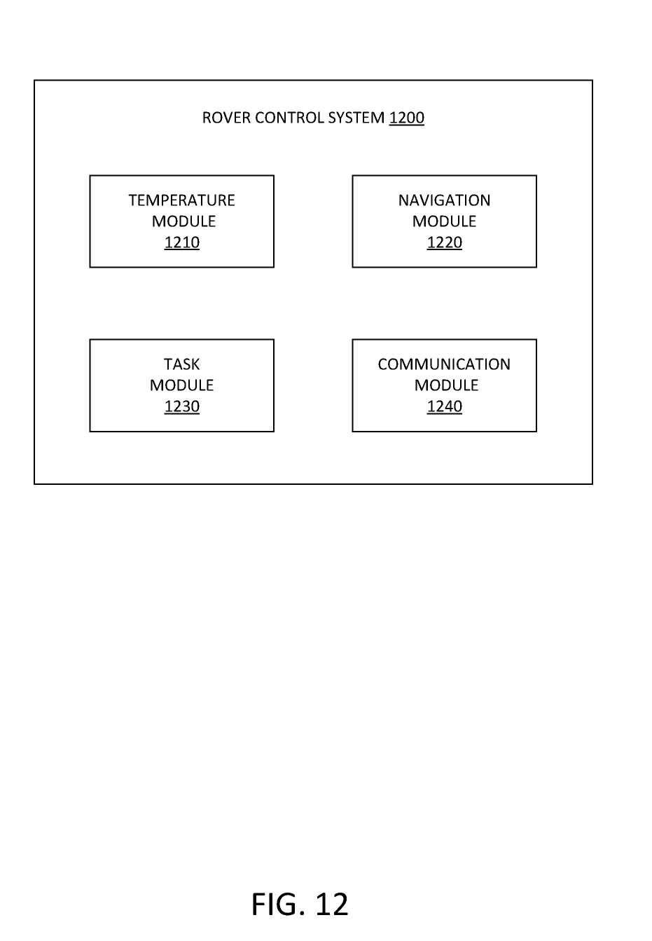

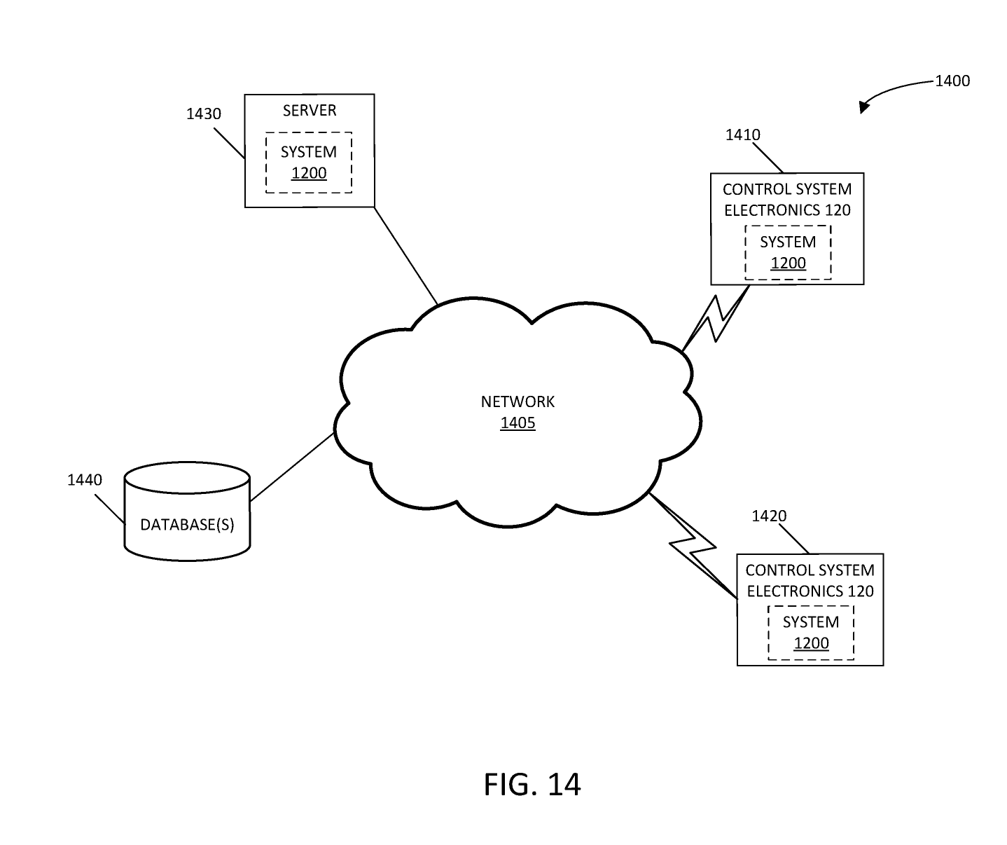

FIG. 12 is a block diagram showing a rover control system 1200 in terms of modules according to an example embodiment. The modules include a temperature module 1210, a navigation module 1220, a task module 1230, and a communication module 1240. One or more of the modules of system 1200 may be implemented in the control system electronics 120 or server 1430 of FIG. 14. The modules may include various circuits, circuitry and one or more software components, programs, applications, or other units of code base or instructions configured to be executed by one or more processors included in the control systems electronics 120 or server 1430. Although modules 1410, 1420, 1430, and 1440 are shown as distinct modules in FIG. 12, it should be understood that modules 1410, 1420, 1430, and 1440 may be implemented as fewer or more modules than illustrated. It should be understood that any of modules 1410, 1420, 1430, and 1440 may communicate with one or more components included in system 1400 (FIG. 14), such as the control system electronics 120, server 1430 or database(s) 1440.

The temperature module 1210 may be a software or hardware implemented module that is configured to monitor the temperature of the temperature-controlled compartments (e.g., compartments 315, 320, 510, 515, 520, and 525 described above) coupled to the modular robotic rover described herein. The temperature module 120 may be configured to control the cooling and heating mechanism (e.g., mechanism 120 described above) to cool or heat the items stored in the temperature-controlled compartment. In some embodiments, the temperature module 1210 may wirelessly transmit temperature data from the rover to the server 1430, and receive instructions to adjust the temperature of the temperature-controlled compartments. In other embodiments, the temperature module 1210 autonomously (without instructions from a server) determines if the temperature of the temperature-controlled compartment needs to be adjusted.

The navigation module 1220 may be a software or hardware implemented module that is configured to control various components of the rover to cause it to navigate a route. The navigation module 1220 may be configured to receive, store and analyze route instructions and control the drive train of the rover to navigate the rover according to the route to a destination location. In some embodiments, the navigation module 1220 is configured to detect an event during navigation based on data sensed by one or more sensors coupled to the rover, and dynamically update the route instructions based on the detected event. For example, the navigation module 1220 may detect an obstacle during navigation, and dynamically control the rover to avoid the detected obstacle. As another example, the navigation module 1220 may receive traffic or weather information and dynamically update the route instructions based traffic or weather information. As another example, the navigation module 1220 may receive an updated destination location from the server 1430, and dynamically update the route instructions stored in the memory of the control systems electronics 120.

The task module 1230 may be a software or hardware implemented module that is configured to receive, store, and analyze instructions for performing various tasks using the rover. As described above, the rover is capable of coupling to different attachments to perform different tasks. Based on the attachment coupled to the rover, the task module 1230 is configured to analyze task instructions, and operate and control the attachment according to task instructions.

The communication module 1240 may be a software or hardware implemented module that is configured to enable the rover to communicate with the server 1430. The communication module 1240 may be configured to receive, transmit and manage data and communications from and to the server 1430.

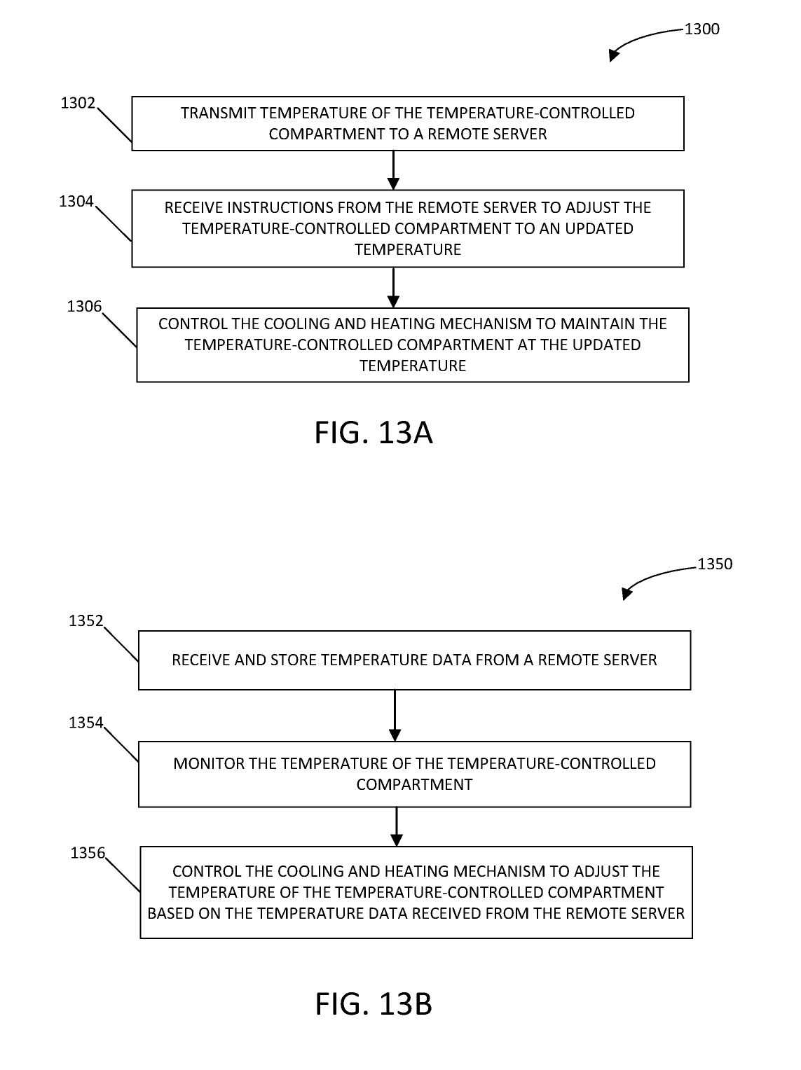

FIG. 13A is a flowchart showing an exemplary method 1300 for a semi-autonomous modular robotic rover, according to an example embodiment. The steps of method 1300 may be performed by one or more modules shown in FIG. 12.

At step 1302, the temperature module 1210 transmits temperature information of one or more temperature-controlled compartments (e.g., temperature-controlled compartments 210, 315, 320, 510, 515, 520, 525) coupled to the modular robotic rover to a remote server (e.g., 1430). The temperature information is based on data sensed by one or more temperature sensors (e.g., sensors 160) coupled to the rover and/or the temperature-controlled compartments.

At step 1304, the temperature module 1210 receives instructions from the remote server to adjust the temperature of one or more of the temperature-controlled compartments coupled to the modular robotic rover. The instructions from the remote server include an updated temperature to which the current temperature of the temperature-controlled compartments is adjusted to. Where the modular robotic rover is coupled to two or more compartments, the instructions from the remote server also include information identifying the compartment for which the temperature is to be adjusted. The remote server may determine the instructions based on the contents of the compartment and predetermined temperature criteria related to the contents.

At step 1306, the temperature module 1210 controls the cooling and heating mechanism (e.g., cooling and heating mechanism 220) to adjust the temperature of one or more temperature-controlled compartments and maintain it at the updated temperature received from the remote server. The temperature module 1210 causes the cooling and heating mechanism, via the control systems electronics 120, to cool or heat a specified temperature-controlled compartment. In an example embodiment, the temperature module 1210 causes the cooling and heating mechanism to turn on turn off, or increase or decrease the temperature as requested to adjust the temperature of a specified temperature-controlled compartment.

In an example embodiment, the navigation module 1220 receives, from the remote server, and stores route instructions in the memory of the control system electronics 120 for navigating the modular robotic rover from an origin location to a destination location. The origin location may be a specified geographic location, or it may be determined based on data sensed by a location sensor or GPS coupled to the modular robotic rover. The remote server includes the destination location in the route instructions. The navigation module 1220 analyzes the route instructions and controls the drive train of the modular robotic rover to navigate the rover according to the route instructions to the destination location.

In an example embodiment, the navigation module 1220 detects an event during navigation based on data sensed by one or more sensors coupled to the modular robotic rover. The navigation module 1220 dynamically updates the route instructions stored in the memory based on the detected event. The detected event may indicate an obstacle in the rover's navigation path, and the navigation module 1220 is configured to dynamically avoid obstacles during navigation. The detected event may include traffic or weather information that may require an update to the rover's navigation route. As another example, the detected event may include an updated destination location. The navigation module 1220 analyzes the updated route instructions and controls the drive train to navigate the rover according to the updated route instructions.

FIG. 13B is a flowchart showing an exemplary method 1350 for an autonomous modular robotic rover, according to an example embodiment. The steps of method 1350 may be performed by one or more modules shown in FIG. 12.

At step 1352, the temperature module 1210 receives and stores temperature data for one or more temperature-controlled compartments (temperature-controlled compartments 210, 315, 320, 510, 515, 520, 525) from the remote server (e.g., server 1430). The temperature data includes at least a temperature for a specified temperature-controlled compartment, which may be based on the item or items stored in the specified temperature-controlled compartment.

At step 1354, the temperature module 1210 monitors the temperature of one or more of the temperature-controlled compartments using one or more temperature sensors (e.g., sensors 160) coupled to the modular robotic rover or the compartments. At step 1356, the temperature module 1210 controls the cooling and heating mechanism (e.g., cooling and heating mechanism 220) to adjust the temperature of one or more temperature-controlled compartments based on the temperature data received from the remote server and the monitored temperature. The temperature module 1210 causes the cooling and heating mechanism, via the control systems electronics 120, to cool or heat a specified temperature-controlled compartment. In an example embodiment, the temperature module 1210 causes the cooling and heating mechanism to turn on or turn off, or increase or decrease in intensity to adjust the temperature of a specified temperature-controlled compartment.

In an example embodiment, the navigation module 1220 receives from the remote server, a map with a destination location on the map. The map and destination location are stored in the memory of the control systems electronics 120. The map may be of a particular geographic area. The navigation module 1220 analyzes the map and generates route instructions to navigate to the destination location from a current location of the rover. The current location of the rover may be determined based on a location sensor or GPS coupled to the modular robotic rover. The route instructions generated by the navigation module 1220 are stored in the memory of the control systems electronics 120. The navigation module 1220 is also configured to control the drive train to navigate the rover according to the route instructions to the destination location.

In an example embodiment, the navigation module 1220 or the task module 1230 is configured to receive, from the remote server, mission information or task information and generate the route instructions based on the mission information or task information. The mission information or task information may include instructions to traverse an entire area in the map from the current location of the rover to the destination location. For example, the modular robotic rover may be coupled to an attachment providing a mowing deck, and the mission or task information indicates to the rover to mow an area (e.g., lawn) depicted in the map. In this case, the navigation module 1220 or the task module 1230 generates route instructions to traverse the entire area in the map to mow the area. The mission information or task information may include instructions to deliver an item from the current location of the rover to the destination location, and the navigation module 1220 generates route instructions based on the mission information or task information.

FIG. 14 illustrates a network diagram depicting a system 1400 for implementing the rover system described herein. The system 1400 can include a network 1405, a control systems electronics 1410 coupled to a rover, a control systems electronics 1420 coupled to another rover, a server 1430, and database(s) 1440. Each of components 1410, 1420, 1430, and 1440 is in communication with the network 1405.

In an example embodiment, one or more portions of network 1405 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

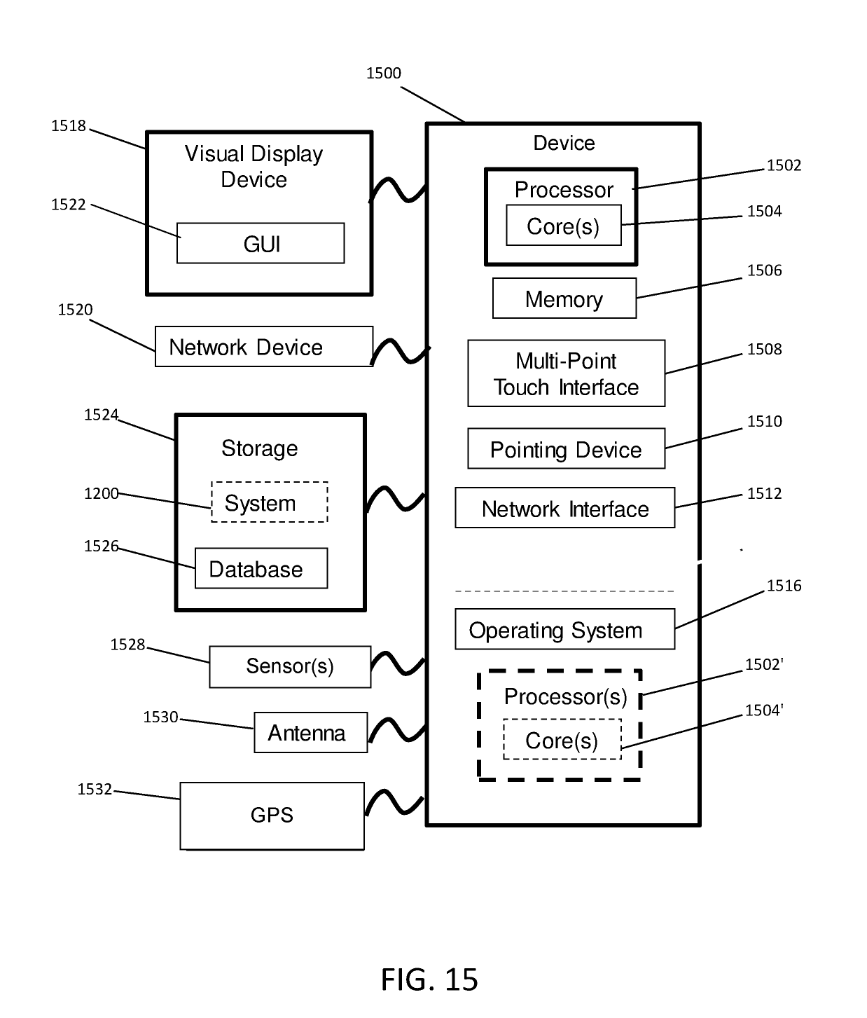

The control systems electronics 1410 and 1420 is coupled to the rover as described above in relation to the control systems electronics 120 above and is configured to perform one or more functionalities described in relation with the control systems electronics 120 above. The control systems electronics 1410 and 1420 may include one or more components described in relation to device 1500 of FIG. 15. The control systems electronics 1410 and 1420 may connect to network 1405 via a wired or wireless connection.

In an example embodiment, some of the components of the rover control system 1200 may be included in the control system electronics 1410, 1420, while the other components are included in the server 1430. Some of the functionalities of the rover control system described herein may be performed by the control system electronics 1410, 1420, while other of the functionalities may be performed by the server 1430.

Each of the database(s) 1440 and server 1430 is connected to the network 1405 via a wired or wireless connection. The server 1430 includes one or more computers or processors configured to communicate with the control system electronics 1410, 1420, and database(s) 1440 via network 1405. The server 1430 transmits data, instructions and communications to the control system electronics 1410, 1420 and/or facilitates access to the content of database(s) 1440. Database(s) 1440 include one or more storage devices for storing data and/or instructions (or code) for use by the control system electronics 1410, 1420 and server 1430. Database(s) 1440, and/or server 1430, may be located at one or more geographically distributed locations from each other and from the control system electronics 1410, 1420. Alternatively, database(s) 1440 may be included within the server 1430.

FIG. 15 is a block diagram of an exemplary device 1500 that may be used to implement exemplary embodiments of the rover control system 1200 described herein. For example, device 1500 may be the remote server or the control systems electronics 120 coupled to the modular robotic rover described herein. The device 1500 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 1506 included in the device 1500 may store computer-readable and computer-executable instructions or software for implementing exemplary embodiments of the rover control system 1200. The device 1500 also includes configurable and/or programmable processor 1502 and associated core 1504, and optionally, one or more additional configurable and/or programmable processor(s) 1502′ and associated core(s) 1504′ (for example, in the case of computer systems having multiple processors/cores), for executing computer-readable and computer-executable instructions or software stored in the memory 1506 and other programs for controlling system hardware. Processor 1502 and processor(s) 1502′ may each be a single core processor or multiple core (1504 and 1504′) processor.

Memory 1506 may include a computer system memory or random access memory, such as DRAM, SRAM, EDO RAM, and the like. Memory 1506 may include other types of memory as well, or combinations thereof.

A user may interact with the device 1500 through a visual display device 1518 or a visual display interface, which may display one or more graphical user interfaces (GUI) 1522 to communicate information to a user. The device 1500 may include other I/O devices for receiving input from a user, for example, a keyboard, a touchpad, a touch screen interface, or any suitable multi-point touch interface 1508 and/or a pointing device 1510 (e.g., a mouse, stylus pen, touch screen). The multi-point touch interface 1508 and the pointing device 1510 may be coupled to or included with the visual display device 1518.

The device 1500 may include or be coupled to other suitable I/O peripherals, for example, sensors 1528 and global positioning system (GPS) 1532. As described herein, the modular robotic rover is coupled to one or more sensors, and the sensors in communication with the control systems electronics (e.g., device 1500). Such sensors include, but are not limited to, a distance sensor, a laser, an infrared sensor, an image sensor or imaging device, an optical sensor, a temperature sensor, a chemical substance sensor, a gas emission sensor, a humidity sensor, a location sensor, and others. The GPS 1532 is coupled to the modular robotic rover and in communication with the control systems electronics (e.g., device 1500) to provide location information of the modular robotic rover.

The device 1500 may also include one or more storage devices 1524, such as a hard-drive, CD-ROM, or other computer readable media, for storing data and computer-readable instructions and/or software that implement exemplary embodiments of the rover control system 1200 described herein. Exemplary storage device 1524 may also store one or more databases for storing any suitable information required to implement exemplary embodiments. For example, exemplary storage device 1524 can store one or more databases 1526 for storing information, such task instructions, route navigation instructions, sensor data sensed by the sensors coupled to the modular robotic rover, and/or any other information to be used by embodiments of the rover control system 1200 and the modular robotic rover 100. The databases may be updated manually or automatically at any suitable time to add, delete, and/or update one or more items in the databases.

The device 1500 can include a network interface 1512 configured to interface via one or more network devices 1520 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the device 1500 can include one or more antennas 1530 to facilitate wireless communication (e.g., via the network interface) between the device 1500 and a network. The network interface 1512 may include a built-in network adapter, network interface card, PCMCIA network card, card bus network adapter, wireless network adapter, USB network adapter, modem or any other device suitable for interfacing the device 1500 to any type of network capable of communication and performing the operations described herein. Moreover, the device 1500 may be any computer system, such as a PC, laptop, handheld computer, tablet computer (e.g., the iPad™ tablet computer), mobile computing or communication device (e.g., the iPhone™ communication device), hardware module, small computing system, embedded computing system, or other form of computing or telecommunications device that is capable of communication and that has sufficient processor power and memory capacity to perform the operations described herein.

The device 1500 may run an operating system 1516, such as versions of the Microsoft® Windows® operating systems, the different releases of the Unix and Linux operating systems, a version of the MacOS® for Macintosh computers, an embedded operating system, a real-time operating system, an open source operating system, a proprietary operating system, or other operating systems capable of running on the device 1500 and performing the operations described herein.

The following description is presented to enable any person skilled in the art to create and use a modular robotic rover and a computer system configuration and related methods to control the modular robotic rover. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components or steps may be replaced with a single element, component or step Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A semi-autonomous modular robotic rover comprising:
two front wheels attached to each other with a front axle;
two back wheels attached to each other with a rear axle;
a drive train coupled to the front or rear axle;
a motor coupled to the drive train to operate the drive train;
a body frame coupled to the front axle and the back axle, the body frame configured to couple to a plurality of removable attachments, wherein the plurality of attachments at least includes an attachment providing a temperature-controlled compartment, wherein a size of the temperature-controlled compartment is configurable;
a cooling and heating mechanism with an integrated electrical interface, the cooling and heating mechanism removably coupled to the body frame and configured to control a temperature of the temperature-controlled compartment;
at least one battery coupled to the motor to provide power to the motor;
one or more sensors configured to detect characteristics of an environment in which the semi-autonomous modular robotic rover is operating; and
a control system that includes electronics to control the drive train and is coupled to the at least one battery, the control system configured to provide power from the at least one battery to the cooling and heating mechanism via the integrated electrical interface to control the temperature of the temperature-controlled compartment;
wherein the control system includes a processor and a memory, and the processor is configured to execute a temperature module, the temperature module when executed:
wireles sly transmits the temperature of the temperature-controlled compartment to a remote server;
wirelessly receives instructions from the remote server to adjust the temperature of the temperature-controlled compartment to an updated temperature; and
controls the cooling and heating mechanism to maintain the temperature-controlled compartment at the updated temperature.

2. The semi-autonomous modular robotic rover of claim 1, wherein the processor is further configured to execute a navigation module, the navigation module when executed:
receives and stores route instructions in the memory for navigation from an origin location to a destination location;
analyzes the route instructions and controls the drive train to navigate the rover according to the route instructions to the destination location;
detects an event during navigation using the one or more sensors;
updates dynamically the route instructions in the memory based on the detected event; and
analyzes the updated route instructions and controls the drive train to navigate the rover according to the updated route instructions.

3. The semi-autonomous modular robotic rover of claim 1, wherein the temperature-controlled compartment is configured to attach to a top surface of the body frame and is configured to store one or more items for heating.

4. The semi-autonomous modular robotic rover of claim 1, wherein the temperature-controlled compartment is configured to attach to a top surface of the body frame and is configured to store one or more items for cooling.

5. The semi-autonomous modular robotic rover of claim 1, wherein the plurality of attachments includes at least a storage compartment configured to attach to a top surface of the body frame and configured to store one or more items.

6. The semi-autonomous modular robotic rover of claim 1, wherein the body frame comprises a mount point at a top surface of the body frame configured to attach to one or more of the plurality of attachments.

7. The semi-autonomous modular robotic rover of claim 1, wherein the body frame comprises a mount point at a bottom surface of the body frame configured to attach to one or more of the plurality of attachments.

8. The semi-autonomous modular robotic rover of claim 1, wherein the body frame includes an electromagnetic mount configured to attach to one or more of the plurality of attachments.

9. The semi-autonomous modular robotic rover of claim 1, wherein the plurality of attachments includes one of a mowing deck, a bush hogging deck, a snow blower, and a street sweeper.

10. The semi-autonomous modular robotic rover of claim 1, wherein the one or more sensors are coupled to the body frame and include at least one of an imaging device, an infrared sensor, and a location sensor.

11. The semi-autonomous modular robotic rover of claim 1, wherein the body frame is adjustable along a length of the body frame.

12. The semi-autonomous modular robotic rover of claim 1, further comprising:
one or more solar panels for charging the one or more batteries.

13. The semi-autonomous modular robotic rover of claim 1, further comprising:
a plurality of ducts formed in a bottom surface of the body frame, the plurality of ducts operatively coupled to the cooling and heating mechanism and configured to control the temperature of the temperature-controlled compartment.

14. The semi-autonomous modular robotic rover of claim 13, wherein the temperature-controlled compartment has one or more corresponding connections to one or more of the plurality of ducts based on a size of the temperature-controlled compartment.

15. An autonomous modular robotic rover comprising:
two front wheels attached to each other with a front axle;
two back wheels attached to each other with a back axle;
a drive train coupled to the front axle;
a motor coupled to the drive train to operate the drive train;
a body frame coupled to the front axle and the back axle, the body frame configured to couple to a plurality of removable attachments, wherein the plurality of attachments at least includes an attachment providing a temperature-controlled compartment, wherein a size of the temperature-controlled compartment is configurable;
a cooling and heating mechanism with an integrated electrical interface, the cooling and heating mechanism removably coupled to the body frame and configured to control a temperature of the temperature-controlled compartment;
at least one battery coupled to the motor to provide power to the motor;
one or more sensors configured to detect characteristics of an environment in which the autonomous modular robotic rover is operating; and
a control system that includes electronics to control the drive train and is coupled to the at least one battery, the control system configured to provide power from the at least one battery to the cooling and heating mechanism via the integrated electrical interface to control the temperature of the temperature-controlled compartment;
wherein the control system includes a processor and a memory, and the processor is configured to execute a temperature module, the temperature module when executed:
receives and stores temperature data from a remote server;
monitors the temperature of the temperature-controlled compartment; and
controls the cooling and heating mechanism to adjust the temperature of the temperature-controlled compartment based on the temperature data received from the remote server.

16. The autonomous modular robotic rover of claim 15, wherein the processor is further configured to execute a navigation module that when executed:
receives and stores a map and a destination location on the map;
analyzes the map and generates route instructions to navigate to the destination location from a current location of the rover;
stores the route instructions in the memory; and
controls the drive train to navigate the rover according to the route instructions to the destination location.

17. The autonomous modular robotic rover of claim 15, wherein the temperature-controlled compartment is configured to attach to a top surface of the body frame and is configured to store one or more items for heating.

18. The autonomous modular robotic rover of claim 15, wherein the temperature-controlled compartment is configured to attach to a top surface of the body frame and is configured to store one or more items for cooling.

19. The autonomous modular robotic rover of claim 15, wherein the body frame comprises a mount point at least one of a top surface and bottom surface of the body frame configured to attach to one or more of the plurality of attachments.

20. A system for a modular robotic rover, the system comprising:
a modular robotic rover comprising:
a motor coupled to a drive train to operate the drive train;
a body frame coupled to a front axle and a back axle;
at least one battery coupled to the motor to provide power to the motor; and
one or more sensors configured to detect characteristics of an environment in which the modular robotic rover is operating;
a plurality of removable attachments configured to couple to the body frame, the plurality of attachments including at least a temperature-controlled compartment, wherein a size of the temperature-controlled compartment is configurable;
a cooling and heating mechanism with an integrated electrical interface, the cooling and heating mechanism removably coupled to the body frame and configured to control a temperature of the temperature-controlled compartment;
and
a control system that includes electronics to control the drive train and coupled to the at least one battery, the control system configured to provide power to the cooling and heating mechanism via the integrated electrical interface to control the temperature of the temperature-controlled compartment.
